(19) United States
(12) Patent Application Publication
(10) Pub. No.: US 2025/0020287 A1
(43) Pub. Date: Jan. 16, 2025

(54) Safety Plug for Hydrogen Vehicles and a System of Such a Plug and a Remote Interface

(71) Applicant: Total Safety Solutions B.V., Oisterwijk (NL)

(72) Inventors: Ralf Arnoldus Antonius Adams, Oisterwijk (NL); Hendricus Johannes Bernardus Wijnans, Oisterwijk (NL); Eric Coenraad Huijding, Oisterwijk (NL)

(73) Assignee: Total Safety Solutions B.V., Oisterwijk (NL)

(21) Appl. No.: 18/903,717

(22) Filed: Oct. 1, 2024

Related U.S. Application Data
(63) Continuation of application No. PCT/NL2023/050045, filed on Feb. 1, 2023.

(30) Foreign Application Priority Data
Apr. 1, 2022 (NL) 2031481

(51) Int. Cl. F17C 13/12

(52) U.S. Cl. CPC F17C 13/12; F17C 2205/037; F17C 2221/012; F17C 2223/0123; F17C 2223/036; F17C 2250/034; F17C 2250/036; F17C 2250/0452; F17C 2250/0478; F17C 2260/04; F17C 2265/04; F17C 2265/065; F17C 2270/0168

(57) ABSTRACT

An attachment for a hydrogen refueling port of a vehicle, the port designed according to the known SAE J2799 international vehicle standard. The attachment is designed to be incompatible with the supply of hydrogen to said vehicle. The attachment includes a nozzle for being connectable to the refueling port and a protruding handle, and at least one of the following features: i) a magnetic element; and ii) a locking device for reversibly locking onto a portion of the refueling port.

### CROSS-REFERENCE TO RELATED APPLICATIONS

This application is a continuation of International Patent Application No. PCT/NL2023/050045, filed Feb. 1, 2023, entitled “A SAFETY PLUG FOR HYDROGEN VEHICLES AND A SYSTEM OF SUCH A PLUG AND A REMOTE INTERFACE”, which claims priority to and the benefit of Netherlands Patent Application No. 2031481, entitled “A SAFETY PLUG FOR HYDROGEN VEHICLES AND A SYSTEM OF SUCH A PLUG AND A REMOTE INTERFACE”, filed Apr. 1, 2022, and the specifications and claims thereof are incorporated herein by reference.

### BACKGROUND OF THE INVENTION

### Field of the Invention

The invention relates to an adapter, also known as a connector, for hydrogen refueling ports on vehicles that run on hydrogen. Such refueling ports are at least partially standardized in Europe and often follow the so-called SAE standard J2799 for safety. Because hydrogen is many times more volatile than the usual fuels and is supplied at many times higher pressures when fueling than LNG and LPG, hydrogen vehicles are designed to automatically protect themselves against self-ignition. This means that when a vehicle detects that it is connected to a refueling gun for the supply of hydrogen, it automatically activates its brakes, puts the vehicle in park or neutral, and/or turns off the vehicle's engine. In road accidents, it may be that hydrogen leaks into the engine due to damage. The combustion engine is usually, with emphasis on usually, designed as an electrochemical cell instead of a more conventional combustion engine with pistons and combustion chambers. In the electrochemical cell, hydrogen is oxidized to generate electrical energy. This is then used to power an electric motor.

### Background

In a traffic accident, hydrogen vehicles are particularly flammable and it is not always clear to emergency services if the electric motor and thus the vehicle is turned off. The turning off of the vehicle is often forgotten, because the driver is often emotional after an accident, or injured. Currently, emergency service workers are often forced to enter the vehicle's cabin themselves, even when it is damaged. However, because there are many different types of vehicles, it is not always immediately clear to the emergency services on the spot that the vehicle has been turned off for sure.

As such, there is a need to secure an electric vehicle against driving away from outside the cabin with a simple action.

### SUMMARY OF THE INVENTION

Embodiments of the present invention are directed to an attachment for a hydrogen refueling port of a vehicle, the port designed according to the SAE J2799 international vehicle standard. The attachment is preferably designed to be incompatible with the supply of hydrogen to said vehicle. The attachment preferably comprises a nozzle for being connectable to the refueling port and a protruding handle. The attachment preferably comprises at least one of the following features: i) a magnetic element; and ii) a locking device for reversibly locking onto a portion of the refueling port.

In an embodiment in which the attachment includes at least feature ii), the attachment may also include a battery and lighting circuit with at least one lamp, and the circuit may also include a sensor which responds to the locking of the attachment, wherein the circuit is configured so that the light illuminates or changes to an affirmative color upon locking. In an embodiment in which the attachment includes at least feature ii), the attachment may also include a gas pressure circuit for providing a super-atmospheric gas pressure to the refueling port, and may also include a manually operable switch disposed on an outside of the attachment for activating said gas pressure circuit. In an embodiment in which the attachment includes at least feature ii), the attachment may also include a gas pressure circuit for providing a super-atmospheric gas pressure to the refueling port, a manually operable switch disposed on an outside of the attachment for activating said gas pressure circuit, and a pressure sensor associated with the lighting circuit for sensing the gas pressure at the refueling port, wherein the lighting circuit is arranged so that the at least one light illuminates alone or changes to an affirmative color, when, in use, the measured gas pressure is also higher than a predetermined value. In some embodiments, the gas pressure circuit comprises a replaceable or refillable gas pressure cartridge.

In an embodiment in which the attachment includes at least feature i), the magnetic element may include a permanent magnet ring integrated with the mouthpiece or arranged around the mouthpiece. The magnetic element may include an electromagnet, a coil of the electromagnet being integrated with the mouthpiece or disposed around the mouthpiece.

Various electronics and communications are described herein. The attachment may also include an infrared receiver for receiving infrared signals from the refueling port and, based on information from these signals, influencing the illumination of the light or a change of color. The attachment may include a communication device, wherein the attachment is configured to communicatively link with a remote human interface, for forwarding information about the locking state of the attachment with the refueling port. The attachment may also be adapted to transmit information about the gas pressure at the refueling port. The attachment may include an infrared receiver for receiving infrared signals from the refueling port, wherein the attachment is also adapted to forward information from received signals to the human interface.

Other features are described herein as well. The attachment may be configured as a dummy plug adapter for the charging port of an electric vehicle, or configured at a distal end to connect to the charging port of an electric vehicle. The attachment may include a gas detection sensor for detecting the presence of hydrogen in the environment of the attachment. The attachment may be part of a system including a communication device, wherein the attachment is configured to communicatively link with a remote human interface, for forwarding information about the locking state of the attachment with the refueling port, and said human interface arranged, in use, to show forwarded information thereto by the attachment on a display to the user, and to provide an audio and/or visual warning signal when the forwarded information is indicative of an incorrect coupling between attachment and refueling port. The system may include a gas detection sensor for detecting the presence of hydrogen in the environment of the attachment, and said human interface arranged, in use, to show forwarded information thereto by the attachment on a display to the user, and to provide an audio and/or visual warning signal when the forwarded information is indicative of an incorrect coupling between attachment and refueling port and/or of a detected presence of hydrogen in the environment of the attachment.

Objects, advantages and novel features, and further scope of applicability of the present invention will be set forth in part in the detailed description to follow, and in part will become apparent to those skilled in the art upon examination of the following, or may be learned by practice of the invention. The objects and advantages of the invention may be realized and attained by means of the instrumentalities and combinations particularly pointed out in the appended claims.

### DETAILED DESCRIPTION OF THE INVENTION

Embodiments of the present invention are directed to an attachment for a hydrogen refueling port of a vehicle as designed according to the known SAE J2799 international vehicle standard, characterized in that the attachment is designed to be incompatible with the supply of hydrogen to said vehicle, and comprising a nozzle (2) for being connectable to the refueling port and a protruding handle, and at least one of the following features:
i) a magnetic element; and
ii) a locking device for reversibly locking onto a portion of the refueling port.

By being designed incompatible with the supply of hydrogen to the vehicle, one should understand that the attachment does not serve as a refueling pistol in the traditional sense and is therefore explicitly designed to not supply hydrogen under filling pressures to the filling port. Known filling pressures start from 300 bar.

The attachment can be designed according to claim 2 to confirm correct and safe coupling of the attachment to the user without having to look inside the vehicle. That is to say the attachment may comprise at least feature ii), a battery and lighting circuit with at least one lamp, for example an LED, and wherein the circuit comprises a sensor, such as a switch, which responds to the locking of the attachment, wherein the circuit is configured so that the light illuminates or changes to an affirmative color, such as green, upon locking. This is especially advantageous if one would be prevented from doing so, such as possibly following an accident.

Some vehicles may be prevented from detecting a magnet at the refueling port after damage. However, because hydrogen is so flammable, extra safety measures are often provided. For example, hydrogen vehicles also automatically activate safety devices when they detect a gas pressure on the refueling port that is above atmospheric pressure at sea level, 1 atm, also higher than 1.01325 bar. Usually, the threshold for activation is a few tens of bar to prevent accidental activation. To this end, the vehicle can be provided with the feature according to claim 3. That is to say the attachment may comprise at least feature ii) and a gas pressure circuit for providing a super-atmospheric gas pressure to the refueling port, wherein optionally a manually operable switch is provided on an outside of the attachment, such as on the handle, for activating said gas pressure circuit. The above can also serve to test the locking of the attachment.

The connection between the attachment and the refueling port will only be gas-tight in relation to the environment if it is indeed locked correctly. To this end the user may use the gas pressure circuit to test whether the system is really gas-tight. If this is not the case, the user will hear hissing or pressurized gas escaping. The user may then disconnect the refueling port attachment and retry locking it. In emergency situations, there are often loud ambient noises, which means that it is not always possible to determine whether the connection between the attachment and the refueling port is air-tight. To this end the features according to claim 4 offer further solution. That is to say the attachment may comprise a pressure sensor associated with the lighting circuit for sensing the gas pressure at the refueling port, and wherein the lighting circuit is arranged so that the at least one light illuminates alone or changes to an affirmative color, such as green, when, in use, the measured gas pressure is also higher than a predetermined value.

Small replaceable CO₂ cartridge, or whipped cream cartridges, could be used to rapidly increase the pressure at the refueling port to well above atmospheric pressure. This makes the system easy and light to use. Accordingly, the gas pressure circuit may be provided with a replaceable or refillable gas pressure cartridge, such as a CO₂ cartridge, or a compressor.

A mouthpiece, of an attachment for a hydrogen refueling port of a vehicle designed according to the known SAE J2799 international vehicle standard, is often shaped like a metal skirt with rubber closing elements. Herein, a magnet element can be provided at a predetermined position. However, an attachment comprising at least feature i), wherein the magnetic element is designed as a permanent magnet ring integrated with the mouthpiece or arranged around the mouthpiece has the advantage that the rotation of the attachment about the longitudinal axis no longer plays a role in detection. This makes the attachment ‘plug & forget’. Alternatively, for improved active control over the vehicle's automatic security means, the attachment may comprise at least feature i), wherein the magnetic element is designed as an electromagnet, a coil of the electromagnet being integrated with the mouthpiece or disposed around the mouthpiece.

Where the refueling port follows SAE standard J2799, it will be designed to communicate infrared with the corresponding refueling pistol of the refueling station. If there the pistol is improperly connected the refueling port communicates this information using its infrared transmitter. Optionally, the attachment can therefore be designed to receive and process such infrared signals, for example to communicate the erroneous connection of the attachment to a user. This can be done via lights on the attachment itself, as according to the features of claim 8. That is to say that the attachment may comprise an infrared receiver for receiving infrared signals from the refueling port and, based on information from these signals, influencing the illumination of the light or a change of color.

However, this may not be necessary. Optionally, the attachment can also simply forward the information to an attached human interface, such as in the embodiment with features according to claim 9, wherein the attachment is provided with a communication device, such as a transceiver of the type WiFi, Bluetooth, or one of telephone networks 2G, 3G, 4G or 5G, wherein the attachment is configured to communicatively link with a remote human interface, such as a phone, tablet, laptop, for forwarding information about the locking state of the attachment with the refueling port. The feature that the attachment can have an infrared receiver is therefore not inextricably linked to any implementation based on light signals with lights provided to the attachment.

Advantageously, the attachment may be designed to simply pass on all sensor information, such as information concerning locking between attachment and refueling port, gas pressure and infrared signals, to a user interface, also known as a human interface. Optionally, a screen can be provided on the attachment wherefrom everything can be read by a user, but to keep the plug compact and robust, it is in some cases more desirable that this human interface is remotely connected to the attachment. One should think of a telephone, tablet or laptop with an app that communicatively links to the attachment via Bluetooth or in another way.

Features according to claims 9, 10 and 11 are therefore quite advantageous in that one can also learn from a distance that the vehicle is coupled correctly with the attachment, and in the case of infrared that the vehicle gives feedback that it recognizes that the attachment is connected properly. This allows the user to inspect from a safe distance whether the vehicle is still secured against driving away. Optionally, the human interface can also issue a warning signal when such a connection fails or is lost. A system according to claim 15 can be provided for this purpose. This is a system of an attachment and a human interface arranged, in use, to show forwarded information thereto by the attachment on a display to the user, and to provide an audio and/or visual warning signal when the forwarded information is indicative of an incorrect coupling between attachment and refueling port.

In some instances an attachment may lock, but there may be damage to the vehicle or port causing a leak. Hydrogen, being a highly volatile gas does not even require an ignition source. Additionally, Hydrogen gas is odorless. Accordingly, the attachment may be designed so as to comprise a gas detection sensor for detecting the presence of hydrogen in the environment of the attachment, wherein optionally the attachment comprises an alarm system for generating at least one of an audio alert and a visual alert when the gas detection sensor detects the presence of hydrogen. Examples of hydrogen gas sensors are a so called Pellistor sensor, or an electrochemical sensor. A variety of electrochemical sensors for the detection of Hydrogen are well known. In one example of the system an audio and/or visual warning could therefore also be given by the human interface when the attachment detects the presence of hydrogen gas with its gas sensor.

Hydrogen vehicles often also use lithium batteries that are powered by an electrochemical cell. In some cases, such as with hybrid vehicles, it is also possible to charge these batteries separately. During such electric charging, the hydrogen vehicle is also designed to automatically protect itself against car locomotion, but then upon detection of a connection to the electric charging port. Optionally, the attachment can therefore also be designed in accordance with the features of claim 12, wherein the attachment is configured as a dummy plug adapter for the charging port of an electric vehicle, or wherein the attachment is configured at a distal end to connect to the charging port of an electric vehicle. An example of a dummy plug is known from https://web.archive.org/web/20220311201211/https://www.totalsafetysolutions.nl/ or WO 2022/081004 A1.

Embodiments of the present invention can include every combination of features that are disclosed herein independently from each other. Although the invention has been described in detail with particular reference to the disclosed embodiments, other embodiments can achieve the same results. Variations and modifications of the present invention will be obvious to those skilled in the art and it is intended to cover in the appended claims all such modifications and equivalents. The entire disclosures of all references, applications, patents, and publications cited above are hereby incorporated by reference. Unless specifically stated as being “essential” above, none of the various components or the interrelationship thereof are essential to the operation of the invention. Rather, desirable results can be achieved by substituting various components and/or reconfiguration of their relationships with one another. The terms, “a”, “an”, “the”, and “said” mean “one or more” unless context explicitly dictates otherwise.

1. An attachment for a hydrogen refueling port of a vehicle, the port designed according to the known SAE J2799 international vehicle standard, wherein the attachment is designed to be incompatible with the supply of hydrogen to said vehicle and the attachment comprises a nozzle for being connectable to the refueling port and a protruding handle, and the attachment comprises at least one of the following features:
i) a magnetic element; and
ii) a locking device for reversibly locking onto a portion of the refueling port.

2. The attachment according to claim 1 comprising at least feature ii), a battery and lighting circuit with at least one lamp, and wherein the circuit comprises a sensor which responds to the locking of the attachment, wherein the circuit is configured so that the light illuminates or changes to an affirmative color upon locking.

3. The attachment according to claim 1 comprising at least feature ii) and a gas pressure circuit for providing a super-atmospheric gas pressure to the refueling port, and further comprising a manually operable switch disposed on an outside of the attachment for activating said gas pressure circuit.

4. The attachment of claim 2 comprising at least feature ii) and a gas pressure circuit for providing a super-atmospheric gas pressure to the refueling port, and further comprising a manually operable switch disposed on an outside of the attachment for activating said gas pressure circuit, and further comprising a pressure sensor associated with the lighting circuit for sensing the gas pressure at the refueling port, and wherein the lighting circuit is arranged so that the at least one light illuminates alone or changes to an affirmative color, when, in use, the measured gas pressure is also higher than a predetermined value.

5. The attachment according to claim 3, wherein the gas pressure circuit comprises a replaceable or refillable gas pressure cartridge.

6. The attachment according to claim 1 comprising at least feature i), wherein the magnetic element comprises a permanent magnet ring integrated with the mouthpiece or arranged around the mouthpiece.

7. The attachment according to claim 1, comprising at least feature i), wherein the magnetic element comprises an electromagnet, a coil of the electromagnet being integrated with the mouthpiece or disposed around the mouthpiece.

8. The attachment according to claim 1 comprising an infrared receiver for receiving infrared signals from the refueling port and, based on information from these signals, influencing the illumination of the light or a change of color.

9. The attachment according to claim 2 comprising a communication device, wherein the attachment is configured to communicatively link with a remote human interface, for forwarding information about the locking state of the attachment with the refueling port.

10. The attachment according to claim 9, wherein the attachment is also adapted to transmit information about the gas pressure at the refueling port.

11. The attachment according to claim 9, comprising an infrared receiver for receiving infrared signals from the refueling port, wherein the attachment is also adapted to forward information from received signals to the human interface.

12. The attachment according to claim 1, wherein the attachment is configured as a dummy plug adapter for the charging port of an electric vehicle, or wherein the attachment is configured at a distal end to connect to the charging port of an electric vehicle.

13. An attachment according to claim 1 comprising a gas detection sensor for detecting the presence of hydrogen in the environment of the attachment.

14. A system of an attachment according to claim 1, comprising a communication device, wherein the attachment is configured to communicatively link with a remote human interface, for forwarding information about the locking state of the attachment with the refueling port, and said human interface arranged, in use, to show forwarded information thereto by the attachment on a display to the user, and to provide an audio and/or visual warning signal when the forwarded information is indicative of an incorrect coupling between attachment and refueling port.

15. A system of an attachment according to claims 9, comprising a gas detection sensor for detecting the presence of hydrogen in the environment of the attachment, and said human interface arranged, in use, to show forwarded information thereto by the attachment on a display to the user, and to provide an audio and/or visual warning signal when the forwarded information is indicative of an incorrect coupling between attachment and refueling port and/or of a detected presence of hydrogen in the environment of the attachment.

16. The attachment according to claim 2 wherein the lamp comprises an LED, the sensor comprises a switch, and the color is green.

17. The attachment according to claim 5 wherein the cartridge comprises a CO2 cartridge or compressor.

18. The attachment of claim 9, wherein the communication device comprises a transceiver of WiFi, Bluetooth or one of the telephone networks 2G, 3G, 4G or 4G, and the remote human interface comprises a phone, tablet, or laptop.

19. The attachment according to claim 9, wherein the attachment is also adapted to transmit information about the gas pressure at the refueling port.

20. An attachment according to claim 1 comprising an alarm system for generating at least one of an audio alert and a visual alert when the gas detection sensor detects the presence of hydrogen.
